(19) United States
(12) Patent Application Publication
(10) Pub. No.: US 2018/0037779 A1
(43) Pub. Date: Feb. 8, 2018

(54) HOTMELT ADHESIVE WITH ENHANCED UV STABILITY AND USE FOR PRODUCING A MULTILAYER POLYMERIC SHEET

(71) Applicant: SIKA TECHNOLOGY AG, Baar (CH)

(72) Inventors: Doreen JANKE, Alveslohe (DE); Mathias CORDES, Hamburg (DE); Björn FUNKE, Lüneburg (DE)

(73) Assignee: SIKA TECHNOLOGY AG, Baar (CH)

(21) Appl. No.: 15/555,059

(22) PCT Filed: Mar. 4, 2016
(86) PCT No.: PCT/EP2016/054655

§ 371 Date: Aug. 31, 2017

(30) Foreign Application Priority Data
Mar. 4, 2015 (EP) 15157536.2

(51) Int. Cl. C09J 123/14; C08L 23/22; C08L 23/14; B32B 27/32; B32B 13/04; B32B 13/12; B32B 13/14; C09J 123/22; C08L 51/06

(52) U.S. Cl. CPC C09J 123/142; C09J 123/22; C08L 23/22; C08L 23/142; C08L 51/06; B32B 13/045; B32B 13/12; B32B 13/14; B32B 27/32; B32B 2037/1215

(57) ABSTRACT

A hotmelt adhesive composition includes at least one polyolefin polymer (P) which is solid at 25° C. and is preferably a thermoplastic poly-α-olefin and more preferably an atactic poly-α-olefin (APAO), at least one polyolefin resin (PH) which is liquid at 25° C. and is preferably based on polyisobutylene, and optionally at least one polyolefin wax (PW) which is preferably a maleic anhydride-grafted polyolefin wax and more preferably a maleic anhydride-grafted polypropylene or polyethylene wax. The hotmelt adhesive composition is notable not only for high intrinsic tack and effective adhesion to low-energy surfaces but also for advantageously high UV integrity.

### TECHNICAL FIELD

The invention relates to the field of hot-melt adhesives and also to the use of the hot-melt adhesive composition of the invention in the manufacture of a multilayered polymeric sheeting. The present invention further provides a composited body comprising the hot-melt adhesive composition.

### PRIOR ART

Hot-melt adhesives have been known for a long time and are used as lamination and assembly adhesives. Waterproof membranes providing protection against entry of subsoil water are known in the building construction industry.

For example, WO 2010/043 661 A1 describes a subsoil water entry prevention membrane which is waterproof and comprises a bulkhead layer and a bond layer, said bond layer being arranged on one side of the bulkhead layer. The membrane further includes a sealant, which is arranged in a discontinuous manner between the bond layer and the bulkhead layer.

WO 2014/029 763 A1 discloses subsoil water entry prevention membranes which are waterproof and include a bulkhead layer and a functional layer. The functional layer of this waterproof membrane contains an adhesion promoter and a thermoplastic polymer whose consistency changes on contact with a strong alkaline medium. The thermoplastic polymer thus ensures that the functional layer is nontacky at the time of processing by casting with liquid concrete, but becomes tacky on contact with concrete to form a firm bond with the cast concrete.

Waterproof membranes for protecting buildings against water entry frequently have a coating with a hot-melt adhesive which, as a lamination adhesive, ensures the bonding of a bulkhead layer to a functional layer, such as a fibrous nonwoven web, whereinto liquid concrete is able to penetrate, or directly to the applied concrete. Hot-melt adhesives of this type have to have a specific set of properties. To ensure optimum protection for the concrete against moisture and water from the subsoil even after possible damage to the waterproof membrane (and so prevent lateral migration), the hot-melt adhesive has to display, when cooled back down, a high level of adherence to the bulkhead layer and to the functional layer. Since the bulkhead layer usually consists of materials having a low level of surface energy, the adhesive has to display an efficient development of adhesion when applied to materials such as polyolefins, in particular polyethylene or ethylene-vinyl acetate copolymers.

The adhesive, after as well as before hardening, should also have an adequate degree of self-tack and be very soft. Since the adhesive comes into contact with liquid concrete, it should also display a high stability to hydrolysis. Finally, the hot-melt adhesive should have a sufficient degree of initial tack before hardening in order that, in the industrial fabrication of waterproof membranes from a bulkhead layer and a functional layer, the two layers may be bonded together.

This problem is addressed by WO 2011/023 768 A1, which describes hot-melt adhesives based on 25° C. solid polyolefins, soft resins having a softening point between −10° C. and 40° C. and polar-modified polyolefin waxes. These hot-melt adhesives display good adherence and early-strength properties on polyolefin substrates.

To prevent lateral migration in this context, deep penetration of the hot-melt adhesive into the functional layer is required before hardening of said adhesive. Ideally, the concrete having been applied to the functional layer penetrates through to the hot-melt adhesive and thus binds to the hot-melt adhesive, ensuring a high degree of protection against lateral migration.

However, prior art hot-melt adhesive compositions for use of substrates having low surface energy have the disadvantage of insufficient UV resistance. This represents a substantial problem particularly in the case of large-scale building projects or building projects in countries where the membranes are exposed to intensive sunlight, since the membranes coated with the hot-melt adhesive are exposed to daylight for up to some weeks in some cases. The UV light leads to some embrittlement of the adhesive, leading to some detachment of fibrous nonwoven web layers applied to a bulkhead layer. This in turn has the consequence that water penetrating underneath the bulkhead layer may, according to the degree of detachment, come to be distributed over a large area, making it very difficult to localize the leak in the membrane. Hence the known membranes fail to provide an adequate degree of protection against lateral migration.

U.S. Pat. No. 3,868,433 describes thermoplastic adhesive-type compositions based on mixtures of 5 to 95 wt % of a conventional thermoplastic base component for hot-melt adhesives in the form of a polyolefin and 95 to 5 wt % of a C₂ to C₈ polyolefin polymer grafted with 0.1 to 50 wt % of a carboxylic acid monomer or a derivative thereof. The modification with the acid is stated to improve the adhesion properties to metal surfaces and the thermal stability of the adhesive bond.

EP 2 172 529 A1 describes hot-melt adhesive compositions which are based on mixtures of thermoplastic elastomers, resin tackifiers having an acid number in the range from 100 to 300 mgKOH/g, terpene phenolic resins and/or polybutylene, synthetic oil and a maleic acid-grafted polyethylene wax and are stated to be dispersible in alkaline media. The adhesives described are stated to have improved removability from substrates such as glass or PET bottles in that they can be peeled off without residues of adhesive being left behind on the substrate.

### SUMMARY OF THE INVENTION

The problem addressed by the present invention is therefore that of providing hot-melt adhesive compositions that have a very wide spectrum of adherence, adhere readily to low-energy surfaces and, what is more, are notable for a high level of UV stability.

This problem is surprisingly solved by a hot-melt adhesive composition as claimed in Claim 1. The hot-melt adhesive compositions according to the present invention have a broad spectrum of adhesion, are notable for a high level of adherence to sheets of low surface energy such as polyolefin sheets, in particular polyethylene sheets, and display very good resistance to UV over prolonged periods.

The hot-melt adhesive composition according to the invention is further stable in storage and efficient to process—and sufficiently long of stable viscosity—under the customary application conditions, in particular in the temperature range from 150 to 200° C. The hot-melt adhesive composition further has a suitable self-tack and also good resistance to environmental influences in general.

The hot-melt adhesive compositions are further very advantageous from occupational hygiene and workplace safety aspects.

Further aspects of the present invention relate to the use of the hot-melt adhesive composition in the manufacture of multilayered polymeric sheetings and for adhesively bonding polyolefin materials to foams, fibrous materials or sheets.

The present invention further provides a composited body as claimed in Claim 13.

Preferred embodiments of the invention are subject-matter of dependent claims.

### WAYS TO CARRY OUT THE INVENTION

In a first aspect, the present invention provides a hot-melt adhesive composition comprising
a) at least one 25° C. solid polyolefin polymer P;
b) at least one 25° C. liquid polyolefin resin PH, preferably polyisobutylene, and optionally
c) at least one polyolefin wax PW.

“Softening point” herein at each instance is to be understood as meaning the softening point measured by the ring-and-ball method of DIN EN 1238.

“Room temperature” herein is to be understood as meaning a temperature of 25° C.

The bold designations such as P, PH, PW, S1, S2 and the like herein merely serve for identification and to assist the reader.

The term “polymer” herein comprehends, on the one hand, a collective—prepared via a polymerization (chain-growth addition polymerization, polyaddition polymerization or condensation polymerization) reaction—of macromolecules that are chemically uniform but differ in terms of degree of polymerization, molar mass and chain length. The term, on the other hand, also comprehends derivatives of such a collective of macromolecules from polymerization reactions, i.e. compounds which were obtained by reactions, as for instance additions or substitutions, of functional groups on given macromolecules and which may be chemically uniform or chemically nonuniform. The term further also comprehends so-called prepolymers, i.e. reactive oligomeric pre-adducts whose functional groups are involved in the construction of macromolecules.

“α-Olefin” herein is to be understood as meaning, in keeping with the customary definition, an alkene of the empirical formula CₓH₂ₓ (where x corresponds to the number of carbon atoms) which has a C═C double bond on the first carbon atom (the α-carbon, that is). Examples of α-olefins include ethylene, propylene, 1-butene, 1-pentene, 1-hexene, 1-heptene and 1-octene, whereas 1,3-butadiene, 2-butene or styrene are not α-olefins for the purposes of this document.

The polyolefin polymer P in the composition according to the present invention is suitably a thermoplastic polyolefin, in particular a thermoplastic poly-α-olefin, and preferably an atactic poly-α-olefin (APAO) and more preferably a propene-rich poly-α-olefin. Atactic poly-α-olefins are obtainable via chain-growth addition polymerization of α-olefins, in particular ethene, propene and 1-butene, for example by means of Ziegler-Natta catalysts, and have an amorphous structure as compared with other polyolefins. These poly-α-olefins may be homopolymers or copolymers.

The polyolefin polymer for the purposes of the present invention is more particularly a polymer whose repeat units are exclusively in the form of α-olefins. This stipulation thus forecloses copolymers or graft copolymers with monomers not covered by the generic term “α-olefin”. These include particularly (meth)acrylate esters and also the free (meth)acrylic acid, other unsaturated carboxylic or dicarboxylic acids or anhydrides thereof, and vinyl esters.

The recitation “at least one 25° C. solid polyolefin polymer P” also comprehends mixtures of two or more 25° C. solid polyolefin polymers, while these mixtures may also be mixtures of polyolefin polymers of the same type of polymer (i.e. various polypropylenes, for example) or of different types of polymer. Preferred mixtures of 25° C. solid polyolefin polymers P include mixtures of various atactic poly-α-olefins and mixtures of an atactic poly-α-olefin with polypropylene and/or polyethylene.

A P polyolefin polymer particularly preferred in the context of the present invention is a propene-rich atactic poly-α-olefin produced according to the Ziegler-Natta process, as commercially available for example from Evonik under the trade name Vestoplast® 751.

Preferably, the polyolefin polymer P has a softening point, as measured by the ring-and-ball method of DIN EN 1238, between 70° C. and 170° C., preferably between 80° C. and 120° C. and more preferably between 90° C. and 110° C.

It is further preferable for the molecular weight Mₙ of the polyolefin polymer P to be between 7000 and 25 000 g/mol.

“Molecular weight” herein is always to be understood as meaning the number-average molecular weight Mₙ, which can be determined using gas permeation chromatography (GPC) and suitable polystyrene standards, in accordance with DIN 55672.

As regards the proportion of polyolefin polymer P in the hot-melt adhesive composition according to the present invention, the present invention is not subject to any significant restrictions. In an advantageous embodiment of the present invention, however, the amount of the at least one 25° C. solid polyolefin polymer P is from 10 to 60 wt %, preferably from 30 to 55 wt % and more preferably from 40 to 50 wt %, based on the total weight of the hot-melt adhesive composition.

The hot-melt adhesive composition further contains at least one 25° C. liquid polyolefin resin PH. “Polyolefin resins” in the context of the present invention are polyolefin materials which are 25° C. tacky and non-crystalline and form the polymers of monomers of the general structure CH₂═CR₁R₂, in each of which R₁ is alkyl and R₂ is either likewise alkyl, which may differ from alkyl R₁, or a hydrogen atom. Suitable polyolefin resins for use in hot-melt adhesive compositions of the present invention are therefore specifically atactic polypropylenes or polyisobutylenes, preferably polyisobutylenes. As to which polyisobutylenes are usable, it is of no significance whether they contain a portion of terminal double bonds or whether such double bonds were removed from the polymer by reaction with hydrogen.

The polyolefin resin preferably has, where determinable, a softening point (determined by the ring-and-ball method of DIN EN 1238) of less than −10° C.

The polyolefin resin preferably further has a number-average molecular weight Mₙ in the range from 250 to 5000 g/mol and particularly in the range from 500 to 2500 g/mol. Suitable polyolefin resins advantageously further have a pour point (determined as per DIN 51597) in the range from −10 to +10° C. and particularly from −10 to +5° C. Polyolefin resins of this type are commercially available, for example as Glissopal V230, V500 or V700 from BASF, as Dynapak Poly 230 from Univar GmbH (Essen, Germany), as DAELIM PB 950 from Daelim Industrial Co., Ltd, or as Indopol H100 from Ineos.

The present invention is also not subject to any substantial restrictions as regards the amount of the at least one polyolefin resin PH. However, in-house studies have shown that a less than 30 wt % content leads to an all but minimal self-tack for the hot-melt adhesive composition. Preferably, therefore, the amount of the at least one polyolefin resin PH is not less than 30 wt %, preferably from 30 to 60 wt % and more preferably from 40 to 50 wt %, based on the total weight of the hot-melt adhesive composition.

The hot-melt adhesive composition optionally further contains at least one polyolefin wax PW. “Polyolefin wax” is to be understood as meaning, in contradistinction to polyolefin resin, a material formed of a polyolefin which is solid at temperatures of less than 40° C. and has a partly crystalline structure in the solid state. Reference for the definition of waxes may further be made to the Römpp Chemie Lexikon chemical dictionary, 10^{th} edition, 1999, where further properties of waxes are reported. Polyolefin waxes have these properties and consist at base of polyolefins albeit possibly functionalized with other monomers.

PW polyolefin waxes suitable in the context of the present invention are obtainable, for example, by grafting with polar olefin monomers, for example α,β-unsaturated carboxylic acids and/or their derivatives, such as (meth)acrylic acid or maleic anhydride, and/or substituted and/or unsubstituted styrenes.

Suitable polyolefin waxes PW are further obtainable by thermal degradation of branched or unbranched polyolefin plastics or by direct chain-growth addition polymerization of olefins. Suitable chain-growth addition polymerization processes include, for example, free-radical processes in which the olefins, generally ethylene, are converted at high pressures and temperatures into more or less branched waxes. In other processes for producing suitable polyolefin waxes, ethylene and/or higher α-olefins are polymerized using organometallic catalysts, for example Ziegler-Natta or metallocene catalysts, into branched or unbranched waxes.

The polyolefin wax PW preferably comprises homo- and copolymers of various alkenes, in particular homo- and copolymers of ethene and of propene.

The polyolefin wax PW preferably further comprises homo- and copolymers produced using Ziegler-Natta or metallocene catalysts.

The at least one polyolefin wax PW in the composition of the present invention more preferably comprises a maleic anhydride-grafted polyolefin wax and most preferably comprises a maleic anhydride-grafted polypropylene or polyethylene wax.

The degree of grafting of polyolefin wax PW is advantageously above 1 wt %, particularly above 3 wt %, of polar olefin monomers, particularly maleic anhydride, based on the weight of polyolefin wax PW. This degree of grafting is preferably between 2 and 15 wt %, more preferably between 4 and 15 wt % and most preferably between 6 and 12 wt %.

When the hot-melt adhesive composition of the present invention contains a polyolefin wax PW, the latter should be present in the hot-melt adhesive composition at a proportion of not less than 0.5 wt %. Preferably, the amount of the at least one polyolefin wax PW is more than 1 wt %, preferably from 1 to 20 wt %, more preferably from 3 to 10 wt % and most preferably about 5 wt %, based on the hot-melt adhesive composition.

The polyolefin wax PW preferably has a softening point between 75° C. and 200° C., in particular between 120° C. and 170° C., and/or a 170° C. melt viscosity of 10-10 000 mPa·s, in particular 750-5000 mPa·s.

The above-discussed constituents aside, the hot-melt adhesive composition according to the present invention may contain at least one thermoplastic polymer other than a polyolefin polymer. Preferred thermoplastic polymers are, for example, copolymers of monomers such as ethylene, propylene, butylene or isobutylene with isoprene, vinyl esters, in particular vinyl acetate, and (meth)acrylates. Preference is likewise given to thermoplastic homopolymers of vinyl esters and (meth)acrylates and also to (meth)acrylate copolymers.

Particularly preferred thermoplastic polymers are homo- and copolymers such as ethylene-vinyl acetate copolymers (EVA), in particular with a vinyl acetate content in the range from 10 to 35 wt %, a melt index (determined as per ASTM D1238 at 190° C. and 2.16 kg) of to 1000 g/10 min and a melting point in the range from 60 to 100° C., and also polypropylenes and polyethylenes in grafted and/or non-grafted form. Particularly suitable ethylene-vinyl acetate copolymers are commercially available as Evathane® 28-800 from Arkema or Greenflex® MP35 from Polimeri.

Optionally, the hot-melt adhesive composition according to the present invention may also contain one or more oils, advantageously oils based on polyolefins, although such an addition is less preferable.

Optionally, the hot-melt adhesive composition according to the present invention may further contain a tack enhancer based on a resin other than a polyolefin resin as defined above. Suitable for this purpose are, in particular, aliphatic and cycloaliphatic or aromatic types of hydrocarbon resins obtainable via chain-growth addition polymerization of certain resin oil fractions generated in the refining of petroleum. Resins of this type, which may be modified by hydrogenation or functionalization, for example, are commercially available, for example under the trade names Wing Tack (Cray Valley), e.g. in the form of Wingtack 86, or Escorez (ExxonMobil Chemical Company), e.g. in the form of Escorez 1401. Useful resins further include polyterpene resins prepared by chain-growth addition polymerization of terpenes, for example pinene in the presence of Friedel-Crafts catalysts, further hydrogenated polyterpenes, copolymers and terpolymers of natural terpenes, for example styrene-terpene or other α-methylstyrene-terpene copolymers. Further possibilities include natural and modified rosins, in particular resin esters, glycerol esters of tree resins, pentaerythritol esters of tree resins and tall oil resins and their hydrogenated derivatives and also phenol-modified pentaerythritol esters of resins and phenol-modified terpene resins.

It was determined, in the course of studies underlying this invention, that compositions containing soft resins having a softening point of −10° C. to 40° C. (as determined by the ring-and-ball method of DIN EN 1238), and, in particular, soft resins based on C₅-C₉ hydrocarbons, have a reduced level of UV stability. In the context of the invention described herein, it is accordingly preferable for the hot-melt adhesive compositions to be prepared without the addition of such soft resins and hence to be free from such soft resins.

By contrast, the hot-melt adhesive composition may include further additives selected from the group consisting of fillers, plasticizers, adhesion promoters, UV absorbers, UV and heat stabilizers, optical brighteners, pigments, dyes and driers, or mixtures thereof.

Suitable thermal stabilizers are sterically hindered phenols as marketed inter alia by BASF under the trade name Irganox® 1010.

Suitable UV absorbers and UV stabilizers include, for example, HALS (hindered amine light stabilizer) materials. Suitable HALS stabilizers include, for example, those marketed by BASF under the trade names Chimassorb® 2020 or Chimassorb® 944. Further suitable UV stabilizers are the products marketed by BASF as Tinuvin® 622, Tinuvin® 783 and by Ciba as Tinuvin® 326. Particularly useful as UV absorber and UV stabilizer have been found to be a mixture of Chimassorb® 2020, Tinuvin® 783, Tinuvin® 326 and Irganox® 1010 in a ratio of 1/1/1/0.25.

The total amount of thermal and UV stabilizers to be advantageously included in the hot-melt adhesive composition according to the present invention may be specified as from 0.1 to 7 wt %, in particular as from 0.5 to 5 wt % and preferably as from 2 to 4 wt %. When the amount exceeds a proportion of 7 wt %, the mechanical properties of the hot-melt adhesive are impaired without any additional benefit being yielded by the further improved UV-resistance properties in most applications. The addition, by contrast, of stabilizers at less than 0.1 wt % results in the imparted UV- and heat-stabilizing effect being only weakly developed.

Titanium dioxide (TiO₂) in particular is a useful pigment for the purposes of the present invention. Pigments and specifically titanium dioxide are advantageously included in the hot-melt adhesive composition of the present invention in an amount of 2 to 10 wt %, in particular 3 to 8 wt % and preferably 4 to 7 wt %.

It transpires that it is particularly advantageous for the sum total weight of all 25° C. solid polyolefin polymers P and of all 25° C. liquid polyolefin resins PH and of all polyolefin waxes PW to amount to more than 60 wt % and preferably more than 80 wt % of the hot-melt adhesive composition.

Of particular advantage are in addition hot-melt adhesive compositions consisting essentially of 25° C. solid polyolefin polymers P, 25° C. liquid polyolefin resins PH and optionally polyolefin wax PW, wherein the use of one polyolefin polymer P, one polyolefin resin PH and optionally one polyolefin wax PW is preferable for reasons of processing economy. The term “consisting essentially of” is to be understood as meaning the presence of less than 5 wt % and especially less than 1 wt % proportions of other constituents.

More particularly, the hot-melt adhesive compositions consist of at least one 25° C. solid polyolefin polymer P, at least one 25° C. liquid polyolefin resin PH and optionally at least one polyolefin wax PW.

Production in principle takes the usual form known to the person skilled in the art of hot-melt adhesives.

The hot-melt adhesive compositions are liquefied by heating to melt the thermoplastic ingredients. The viscosity of the hot-melt adhesive compositions should be in line with the application temperature. The application temperature is typically in the range from 150 to 200° C., in particular in the range from 155 to 180° C. The adhesive is readily workable at this temperature. The viscosity, as determined to Brookfield Thermosel, is preferably 1500-50 000 mPa·s in this temperature range. A significantly higher viscosity would make application very difficult. A significantly lower viscosity would render the adhesive so thinly liquid that when applied to the adherend surface it may run off before solidifying due to cooling. More particularly, the viscosity, as determined to Brookfield Thermosel, is preferably in the range of 2500-20 000 mPa·s in the temperature range from 150 to 180° C.

As the adhesive becomes solid and rigid as a result of cooling down, the adhesive bond rapidly develops a high level of initial strength. Care must accordingly be taken with applying an adhesive to ensure that bond formation takes place within the period in which the adhesive has not yet cooled down too much, i.e. bond formation has to take place as long as the adhesive is still liquid and/or at least still tacky and malleable.

It transpires that the hot-melt adhesive compositions described as being in accordance with the present invention have a high level of initial strength; high strengths and flexibilities across a wide range of temperatures; as well as a very high level of UV stability.

The hot-melt adhesive compositions described as being in accordance with the present invention are particularly advantageous for occupational hygiene and workplace safety reasons by virtue of avoiding isocyanates.

It was additionally found that 25° C. liquid polyolefin resin PH provides an improved UV resistance over soft resins.

The hot-melt adhesive compositions of the present invention have an extremely favourable spectrum of adhesion to apolar plastics, such as polyethylene or polypropylene, and thus permit adhesive bonding even without prior application of a primer.

It additionally transpires that the hot-melt adhesive compositions described are very stable in storage, have good processing properties, particularly in the application temperature range from 150 to 200° C., and are stable in viscosity at these temperatures even for a prolonged period. Hardening takes place odourlessly, rapidly and—even in thick-layered applications—without bubbles. The hot-melt adhesive composition has good adherence, in particular a high level of tackiness and instant adherence, and good stability with regard to UV light, environmental influences, especially with regard to aqueous media such as, for example, surfactants, weak acids and alkalis, and is not corrosive.

The hot-melt adhesive compositions described as being in accordance with the present invention are further particularly advantageous by virtue of their resistance to ageing and to heat.

The hot-melt adhesive compositions described above can be used for many different purposes, typically in the building construction and hygiene industries.

It transpires that the hot-melt adhesive compositions described above are very useful for bonding polyolefin materials to foams, fibrous materials or sheets and also in the manufacture of a multi-layered polymeric sheeting.

The hot-melt adhesive compositions are further also very useful for bonding sandwich panels.

A further aspect to the invention relates to a composited body comprising a first substrate S1 which is preferably a polyolefin sheet, a hot-melt adhesive composition as described above, and also a second substrate S2 which is preferably a polyolefin foam or a fibrous polyolefin material, wherein the hot-melt adhesive composition is arranged between the first substrate S1 and the second substrate S2.

“Polyolefin sheet” refers to specifically flexible sheetlike polyolefins in a thickness of 0.05 millimetre to 5 millimetres, which can be rolled up. This accordingly comprehends not only “sheets” in the strict sense of thicknesses below 1 mm, but also seal sheetings as typically used for waterproofing tunnels, roofs or swimming pools in a thickness of typically 1 to 3 mm, in special cases even in a thickness of up to 5 mm. The polyolefin sheets more preferably have a thickness of 0.5-2 mm, most preferably a thickness of 0.7-1.5 mm. Polyolefin sheets of this type are typically produced by spreading, casting, calendering or extrusion and are typically commercially available in rolls or are produced on site. They may have a single-layered or multi-layered construction. It is clear to the person skilled in the art that polyolefin sheets may further also contain still other added substances and processing aids, such as fillers, heat stabilizers, plasticizers, glidants, biocides, flame retardants, antioxidants, pigments, e.g. titanium dioxide or carbon black, and dyes. That is, sheets of this type are also referred to as polyolefin sheets when they do not consist 100% of polyolefins.

The term “polyolefin sheet” in the context of the present invention comprehends not just base materials (i.e. polymers in the polyolefin sheet; the latter may additionally contain, for example, fillers which do not count as part of the “base material”) which are exclusively constructed from α-olefin monomers, but also materials which in addition to α-olefin monomers also contain other monomers. Such additional monomers may, for example, take the form of vinyl carboxylate esters such as vinyl acetate or vinyl propionate or (meth)acrylate esters such as ethyl (meth)acrylate or propyl (meth)acrylate. Vinyl acetate has been found to be a particularly suitable comonomer for such materials in that vinyl acetate, preferably combined with ethylene (to form EVA copolymers), forms an advantageous base material for polyolefin sheets.

When the base material of the “polyolefin sheet” contains a comonomer which itself is not an α-olefin, it is nonetheless preferable for the mass fraction of the non-α-olefin monomers to be lower than that of the α-olefin monomers. Particularly preferred mass fractions of non-α-olefin monomers in the base material of the polyolefin sheet may be specified as up to 30 wt % and especially 5 to 20 wt %.

The second substrate S2, frequently also referred to as a carrier, may be different in type and nature. The substrates may be, for example, of plastics, in particular polyolefins or ABS, metal, coated metal, of plastic, wood, woodbase or fibre materials. The substrate is preferably a solid shaped body.

More particularly, the first substrate S1 is a polyolefin sheet and the second substrate S2 is a porous material, in particular a polyolefin foam or a fibrous polyolefin material.

If required, the surface of the second substrate S2 may be pretreated. Such a pretreatment may more particularly take the form of a cleaning operation or a step of applying a primer. Preferably, however, the application of primers is not necessary.

The composited body described is preferably an article of industrial manufacture, in particular an article in the building construction industry for protecting buildings against entry of subsoil water, such as waterproof membranes for example.

The composited body described is more preferably a waterproof membrane wherein the first substrate S1 is a polyolefin sheet and the second substrate S2 is a porous material, in particular a foamed material or a fibrous material.

In the installed state, therefore, with such a composited body, typically concrete is arranged on that side of the second substrate S2 which faces away from the first substrate S1.

When the composited body is a waterproof membrane, the first substrate S1 typically evinces a high resistance to water pressure and displays good values in tongue tear tests and perforation tests, which is particularly of advantage in relation to mechanical stresses on building sites.

A porous structure for the second substrate S2 is beneficial for the elasticity of the waterproof membrane, which is thereby better able to resist tensile and shear forces. Secondly, it leads to good receptivity for liquid concrete and thus to a firm bond with the liquid concrete and also the hardened concrete. This may be of particular advantage in relation to large angles of inclination in order that the concrete may not slide down on the second substrate S2.

The second substrate S2 is preferably a fibrous material. Fibrous material is throughout the present document to be understood as referring to a material constructed of fibres. The fibres comprise or consist of organic or synthetic material. Cellulose fibres, cotton fibres, protein fibres or synthetic fibres are concerned in particular. Useful synthetic fibres include most preferably fibres of polyester or of a homo- or copolymer of ethylene and/or propylene or of viscose. The fibres in question may be short fibres or long fibres, spun, woven or non-woven fibres or filaments. The fibres may further be directed or straightened fibres. It may further be advantageous to use different fibres—different not only in geometry but also in composition—with one another.

The fibrous material further comprises cavities. These cavities are constructed by suitable methods of production. The cavities preferably are at least partly open and allow the ingress of liquid concrete and/or of the abovementioned hot-melt adhesive composition.

The body constructed from fibres may be produced in the various ways known to the person skilled in the art. Bodies employed in particular are woven fabrics, non-crimp fabrics or knitted fabrics other than knitted fabrics produced by weft knitting with independently-movable needles.

The fibrous material may be a comparatively loose material of continuous-filament or finite fibres, the coherence of which is generally due to the autogenous adherence between the fibres. The individual fibres here may have a preferential direction or be undirected. The body constructed from fibres may be mechanically consolidated by needling, by stitchbonding or by entanglement caused by sharp jets of water. A felt or a fibrous nonwoven web is particularly preferable for use as fibrous material. Preference is further given to fibrous materials having a mesh count of 5-30 per 10 cm. Such layers of fibrous materials offer the same advantages as mentioned above for porous materials, and have low manufacturing costs. Fibrous materials in general can further be made very uniformly, ensuring a comparable penetration by concrete.

The second substrate S2 advantageously consists of a thermoplastic material and the material is selected from the group comprising high-density polyethylene (HDPE), polyethylene terephthalate (PET), polystyrene (PS), polypropylene (PP), polyvinyl chloride (PVC), polyamide (PA) and combinations thereof.

When the composited body is a waterproof membrane, the thickness of the second substrate S2 is typically 0.1-1 mm, preferably 0.2-0.6 mm, more preferably 0.4-0.55 mm.

The hot-melt adhesive composition is arranged between the first substrate S1 and the second substrate S2. However, it may also be of advantage for the hot-melt adhesive composition to partially or completely, preferably partially, penetrate into the substrate S2, resulting in a better bond with the hot-melt adhesive composition.

In the installed state of such a composited body, it may further be advantageous for the bonding of the waterproof membrane to the concrete if the concrete is at least partly in contact with the hot-melt adhesive composition. This may be accomplished as a result of the concrete penetrating the porous material and thus coming into contact with the hot-melt adhesive composition and/or as a result of the hot-melt adhesive composition penetrating the porous material and thus coming into contact with the concrete.

The abovementioned waterproof membranes comprising the hot-melt adhesive composition of the present invention and also the use therein of the hot-melt adhesive composition of the present invention are advantageous in that, firstly, the hot-melt adhesive composition makes possible the use of difficult-to-adhere polyolefin sheets which, owing to their high resistance to water pressure, are extremely advantageous and are notable for high resistance to UV. Secondly, the hot-melt adhesive composition by virtue of its hydrophobicity and ability to resist liquids, its non-corrosive properties and its good adherent properties ensures good compositing of first substrate S1 and second substrate S2. This prevents, for example, cavities between the first substrate S1 and the second substrate S2 and resists the lateral migration of water through the waterproof membrane in the event of a leak.

### EXAMPLES

TABLE 1
Characterization of raw materials used and
designation thereof

| | |
|---|---|
| P | Poly-α-olefin, propene-rich |
| | Molecular weight (Mₙ): between 17 000 and 20 000 g/mol |
| | Melt viscosity (190° C. DIN 53 019): about 50 000 mPa · s |
| | Softening point (ring & ball, DIN EN 1238): |
| | 100° C. |
| | Density: about 0.85 g/cm³ |
| PH | Polyisobutylene (Mₙ 930-970 g/mol; pour point |
| | (ASTM D97): −1° C.) |
| PW | Maleic anhydride-grafted polypropylene (obtained |
| | by metallocene catalysis) |
| | Melt viscosity (170° C. DIN 53 018): about 800 mPa · s |
| | Density: about 0.91 g/cm³ |
| | Dropping point: about 156° C. |
| Stab. | Phenolic heat stabilizer |

Production of Test Membranes

To a TPO membrane 1.2 mm in thickness (from Sika Schweiz) was applied an adhesive comprising 47.5 wt % of P, 47.5 wt % of PH, 4.75 wt % of PW and 0.25 wt % of stabilizer in a coat thickness of 200 g/m². Atop the coat of adhesive was subsequently laminated into it a fibrous nonwoven web (0.5 mm in thickness, of PP, from Polyvlies Frankreich, product name SC 61055001).

A corresponding membrane was produced for comparison, one where the polyolefin resin in the adhesive was replaced by a soft resin (Wingtack 10) (“membrane with composition of the prior art”).

Sample Preparation

Sample preparation was carried out in accordance with the requirements of ASTM 285.

Pull-Off Bond Strength

Pull-off bond strength was determined in accordance with the ISO 4624 tensile pull-off method for adhesion testing. To prepare the test specimens, first concrete was cast against the test membranes and allowed to set for 48 h. A dolly (50 mm diameter) was then glued onto the membrane side and the membrane around the dolly was removed from the concrete. The force required to pull the dolly (with the membrane) off the concrete was then determined using a tensile tester.

Peel-Off Bond Strength

The sample specimens prepared were aged at 25° C. for 48 hours (following concretization of the membrane and setting of the concrete for 48 h) and then had their peel-off bond strength determined with a tensile tester using the following parameters: angle of 90° C., extension rate: 100 mm/min, membrane width: 50 mm, temperature/humidity: 25° C./50% rh.

Tightness Testing

The membranes prepared as described above were used to carry out tightness tests in accordance with the provisions of ASTM D 5385. For testing, the sample is clamped into a device as stipulated in ASTM D 5385 and the area to be tested is subjected to water pressure. This is used to check the areal resistance to lateral migration the membrane provides (sample with precut hole) or the tightness of the lap join. The test was carried out in each case across three pressure stages at a testing pressure of 1 bar for 4 hours at the first stage, a testing pressure of 3 bar for 20 hours at the second stage and a testing pressure of 5 bar for 6 days at the third stage.

On completion of the test, it was possible to ascertain for the membrane whether paper in the test openings is dry and, if not, how far (in cm) the water had been able to advance. Test performance is deemed a pass when the value is 2 cm.

Weathering Tests

The tightness testing was repeated with weathered test membranes exposed outdoors to solar irradiation for 8 weeks in Dubai oriented at a 45° angle facing south. Weathered test membranes in accordance with the present invention gave values ≦2 cm, whereas prior art membranes gave values of >2 cm (see Table 2). The tests accordingly show that membranes produced using the hotmelt adhesive compositions of the present invention have a significantly improved level of UV resistance over membranes of the prior art.

TABLE 2
Characterization of deployed membranes as regards lateral water migration
and bonding to concrete before and after weathering in Dubai for 8 weeks.

| | | Lateral water migration | | | | |
|---|---|---|---|---|---|---|
| | | to ASTM 5385 D | | | Strength of bond | |
| | | Conditions: 7 days/5 bar | | | to concrete | |
| | | Sample of surface | | | Peel off | Pull off |
| | Embedding | Left | Centre | Right | [N/50 mm] | [N/mm²] |
| Before weathering | Membrane of | 0 cm | 0 cm | 2 cm | 20 | 0.27 |
| After weathering | invention composition | ≦2 cm | ≦2 cm | ≦2 cm | No data | No data |
| Before weathering | Membrane of prior | 0 cm | 0 cm | 0 cm | 50-80 | 0.56 |
| After weathering | art composition | >2 cm | >2 cm | >2 cm | No data | No data |

In a further experiment, test strips (50×135 mm) of a 1.2 mm thick TPO membrane coated with a PE/PP nonwoven and the invention adhesive or the prior art adhesive (see above) were laid flat on the floor of a test chamber with the nonwoven side of the strips facing upwards. These test strips were irradiated for a period of 0, 1, 2 and 4 weeks with an SOL 500S lamp at a transmission range of 295 to 3000 nm and an irradiation intensity of 1000 W/m². Subsequently, the degradation of the nonwoven, of the adhesive and of the membrane, the shrinkage behaviour of the nonwoven and the loss of tackiness was evaluated by touch and visual inspection. The results of these tests are reported below in Table 3.

TABLE 3
Evaluation of prior art and invention
membranes after UV irradiation for different periods

| | Membrane of invention | Membrane of prior art |
|---|---|---|
| Sample | composition | composition |
| Irradiation for | | |
| 0 weeks | Tacky, little | Tacky, no tearing out |
| | tearing out of | of fibre, nonwoven |
| | fibre, nonwoven | damaged |
| | undamaged | |
| 1 week | Tacky, no tearing | Nontacky, tearing out |
| | out of fibre | of fibre, nonwoven |
| | | damaged |
| 2 weeks | Membrane tacky, | Nontacky with fibre |
| | nonwoven tacky, | and nonwoven |
| | scarcely any tearing | rupturing, the |
| | out of fibre, | nonwoven is severely |
| | nonwoven slightly | UV-damaged |
| | damaged | |
| 4 weeks | Membrane tacky, | Nontacky with fibre |
| | nonwoven tacky, | tearing and nonwoven |
| | scarcely any tearing | rupturing, the |
| | out of fibre, | nonwoven is severely |
| | nonwoven is UV- | UV-damaged |
| | damaged | |

The outcomes of the irradiation tests show that the adhesive compositions representing the prior art lose their tackiness to a significant extent after just a relatively short period of irradiation. The adhesive compositions representing the invention, by contrast, remain, even over 4 weeks of irradiation time, sufficiently tacky to still be processable.

1. Hot-melt adhesive composition comprising:
a) at least one 25° C. solid polyolefin polymer P,
b) at least one 25° C. liquid polyolefin resin PH, and optionally
c) at least one polyolefin wax PW.

2. Hot-melt adhesive composition according to claim 1, wherein the polyolefin polymer P is a thermoplastic poly-α-olefin.

3. Hot-melt adhesive composition according to claim 1, wherein the polyolefin polymer P has a softening point, as measured by the ring-and-ball method of DIN EN 1238, between 70° C. and 170° C.

4. Hot-melt adhesive composition according to claim 1, wherein the amount of the at least one 25° C. solid polyolefin polymer P is from 10 to 60 wt % based on the hot-melt adhesive composition.

5. Hot-melt adhesive composition according to claim 1, wherein the at least one 25° C. liquid polyolefin resin PH is a polyisobutylene resin.

6. Hot-melt adhesive composition according to claim 1, wherein the amount of the at least one polyolefin resin PH is not less than 30 wt % based on the hot-melt adhesive composition.

7. Hot-melt adhesive composition according to claim 1, wherein the at least one polyolefin wax PW is a maleic anhydride-grafted polyolefin wax.

8. Hot-melt adhesive composition according to claim 1, wherein the amount of the at least one polyolefin wax PW is more than 1 wt % based on the hot-melt adhesive composition.

9. Hot-melt adhesive composition according to claim 1, wherein it additionally contains at least one thermoplastic polymer other than a polyolefin polymer.

10. Hot-melt adhesive composition according to claim 1, wherein the composition is free from soft resins having a softening point, measured by the ring-and-ball method of DIN EN 1238, in the region of −10 to 40° C.

11. Hot-melt adhesive composition according to claim 1, wherein it contains further additives selected from the group consisting of fillers, plasticizers, adhesion promoters, UV absorbers, UV and heat stabilizers, optical brighteners, pigments, dyes and driers, or mixtures thereof.

12. A method of manufacturing a multilayered polymeric sheeting and adhesively bonding polyolefin materials to foams, fibrous materials or sheets utilizing the hot-melt adhesive composition according to claim 1.

13. Composited bodies comprising
a first substrate S1 which is a polyolefin sheet;
a hot-melt adhesive composition according to claim 1, and also
a second substrate S2,
wherein the hot-melt adhesive composition is arranged between the first substrate S1 and the second substrate S2.

14. Composited body according to claim 13, wherein concrete is arranged on that side of the second substrate S2 which faces away from the first substrate S1.

15. Composited body according to claim 13, wherein the second substrate S2 comprises a porous material and the concrete is at least partially in contact with the hot-melt adhesive composition.
